(19) United States
(12) Patent Application Publication
(10) Pub. No.: US 2009/0200943 A1
(43) Pub. Date: Aug. 13, 2009

(54) External-electrode discharge lamp, external-electrode discharge lamp manufacturing method, and backlight unit

(76) Inventors: Hirofumi Yamashita, Osaka (JP); Masanobu Murakami, Osaka (JP); Masao Izumi, Kyoto (JP); Masaru Saitoh, Kyoto (JP)

Correspondence Address: SNELL & WILMER L.L.P. (Panasonic), 600 ANTON BOULEVARD, SUITE 1400, COSTA MESA, CA, 92626, US

(21) Appl. No.: 10/585,595

(22) PCT Filed: Jan. 20, 2005
(86) PCT No.: PCT/JP05/00687

§ 371 Date: Apr. 22, 2009

(30) Foreign Application Priority Data
Jan. 22, 2004 (JP) 2004-014871

(51) Int. Cl. H01J 65/00; H01J 9/38

(52) U.S. Cl. 313/607; 445/53

(57) ABSTRACT

The present invention aims to provide an external-electrode discharge lamp able to suppress luminance variation, a manufacturing method for the lamp, and a backlight unit. A lamp (10) of the present invention includes a glass tube (11) sealed at both ends, and electrodes (18) and (19) provided around outer circumferential peripheries of the ends in the axial direction of the glass tube (11). During operation of the lamp (10), the electrodes (18) and (19) and the glass tube (11) between the electrodes (18) and (19) and a discharge space (14) equivalently function as first and second capacitors, whose capacitances are substantially the same.

### TECHNICAL FIELD

The present invention relates to an external-electrode discharge lamp including a glass tube whose ends are sealed to form a discharge space in which a discharge medium is enclosed, and having electrodes provided around outer circumferential peripheries of the ends of the glass tube, a manufacturing method for the same, and a backlight unit.

### BACKGROUND ART

In recent years, liquid crystal displays have been progressively increasing in size, and these displays employ a direct-type backlight unit in which a plurality of lamps are arranged on a back surface of the display. There are direct-type backlight units that use external-electrode discharge lamps due to the ease of controlling the luminance of each of the plurality of lamps compared to internal-electrode discharge lamps whose electrodes are inside the glass tube.

These external-electrode discharge lamps include a glass bulb composed of a glass tube whose ends are sealed to form a discharge space in which a discharge medium is enclosed, and electrodes provided around outer circumferential peripheries of the ends of the glass bulb. The discharge medium is enclosed in the glass tube at a negative pressure, and the electrodes are constituted from a conductive layer and an adhesive layer provided on an inner circumferential surface of the conductive layer (Patent document 1).

Note that there is demand particularly for thinner and lighter liquid crystal displays, many of the glass tubes used in external-electrode discharge lamps have an outer diameter of 4.0 mm or less, and the ends of the glass tubes are ordinarily sealed-using a tip-off method.

Patent document 1: Japanese Patent Application Publication No. 2003-229092

### DISCLOSURE OF THE INVENTION

### Problems Solved by the Invention

Upon manufacturing an external-electrode discharge lamp with the above structure, however, the inventors of the present invention found that there is a large amount of luminance variation between the ends of the lamp in the axial direction. This luminance variation promotes variation particularly in the luminance of liquid crystal displays that use direct-type backlight units, thereby dramatically reducing their commercial value.

The present invention aims to provide an external-electrode discharge lamp able to reduce luminance variation down to a substantially unnoticeable degree, a manufacturing method for the same, and a backlight unit.

### Means to Solve the Problems

Upon manufacturing and operating the external-electrode discharge lamp disclosed in Patent document 1, the inventors found that there is a large amount of luminance variation between the ends of the lamp in the axial direction. As a result of various examinations, the inventors found that when the ends of a glass tube are tip-off sealed, there are differences in the shapes of the portions of the sealed parts facing the discharge space, and there is a large difference in the capacitances of first and second capacitors at the ends of the glass tube, thereby causing the luminance variation (details are mentioned hereinafter). The present invention has been achieved based on these findings.

In order to achieve the above-mentioned aim, an external-electrode discharge lamp of the present invention is a dielectric barrier discharge type external-electrode discharge lamp including a glass tube whose ends are sealed to form a discharge space in which a discharge medium is enclosed; and two electrodes, each of the electrodes being provided on an outer circumference of a respective end of the glass tube, and the two electrodes and portions of the glass tube between the two electrodes and the discharge space equivalently functioning as a first capacitor and a second capacitor during operation, wherein a capacitance of the first capacitor and a capacitance of the second capacitor have been adjusted to be equal or close in value. According to this structure, it is possible to suppress luminance variation.

Note that “a capacitance of the first capacitor and a capacitance of the second capacitor have been adjusted to be equal or close in value” is a general concept, and includes, for example, adjusting a thickness of portions of the glass tube where the electrodes are provided, adjusting the dielectric constant by providing another member on the portions of the glass tube where the electrodes are provided, adjusting a contact area between the electrodes and the glass tube, and the like.

Also, a difference between values of the capacitance of the first capacitor and the capacitance of the second capacitor may be less than or equal to 20% of a smaller one of the values; and portions, of inner circumferential surfaces of the ends of the glass tube, that correspond to the two electrodes are substantially congruent with respect to shape. Note that regarding “substantially congruent with respect to shape”, the shapes of the portions are congruent as long as the difference between the values of the capacitances in the electrodes is less than or equal to 20% of the smaller value, even if the shapes are different.

Also, a manufacturing method of the present invention is a manufacturing method for an external-electrode discharge lamp including a glass tube sealed at a first site and a second site, the glass tube having a discharge space in which a discharge medium is enclosed at a reduced pressure, the manufacturing method including a fixing step of fixing an insert to an inner circumferential surface of the first site, the insert including an end face having a shape substantially the same as a portion of the sealed first site facing the discharge space when the second site is sealed, the end face facing the discharge space, and an exterior and an interior of the glass tube being linked; a depressurization/filling step of depressurizing the interior of the glass tube and filling the discharge medium; and a plugging step of plugging a portion linking the exterior and the interior of the glass tube in the fixing step.

With an external-electrode discharge lamp manufactured using the above manufacturing method, it is possible to give portions, of the sealed parts of the first and second sites, facing the discharge space substantially the same shape.

Furthermore, a backlight unit of the present invention includes an external-electrode discharge lamp with the above structure, as a light source.

The backlight unit having the above structure enables suppression of luminance variation in the external-electrode discharge lamp. Particularly, it is possible to reduce the luminance variation down to a substantially unnoticeable degree, by setting a difference between the values of the capacitances of the external-electrode discharge lamp to be less than or equal to 20% of the smaller value.

### Effects of the Invention

The external-electrode discharge lamp of the present invention can suppress luminance variation since the capacitances are substantially equal. In particular, luminance variation can be reduced down to a substantially unnoticeable degree in the exemplary case of being used in a backlight unit, if the difference between the capacitances is within 20% of the smaller capacitance.

Also, the capacitances at the electrodes can be made substantially equal by making portions, of the internal circumferential surfaces of the glass tube ends, corresponding to the electrodes substantially congruent with respect to shape.

Also, with an external-electrode discharge lamp manufactured using the above manufacturing method, it is possible to give portions, of the sealed parts of the first and second sites, facing the discharge space substantially the same shape. For this reason, when the two electrodes and the glass tube between the two electrodes and the discharge space equivalently function as a first capacitor and a second capacitor during operation of the external-electrode discharge lamp manufactured using the above manufacturing method, the capacitor capacitances can be made substantially equal, and it is possible to reduce luminance variation down to a substantially unnoticeable degree.

Also, the backlight unit of the present invention can reduce luminance variation down to an unnoticeable degree due to the inclusion of an external-electrode discharge lamp with the above structure.

### BRIEF DESCRIPTION OF THE DRAWINGS

FIG. 1 is a schematic perspective view of a backlight unit according to embodiment 1;

FIG. 2 is a longitudinal sectional view of a lamp according to embodiment 1;

FIG. 3 shows an outline of manufacturing steps for a glass bulb;

FIG. 4 shows an outline of manufacturing steps for the glass bulb;

FIGS. 5A and 5B show an outline of an experiment to measure voltage levels;

FIGS. 6A and 6B show experimental results during operation of a lamp having electrodes substantially equal in size, and an electric potential distribution at that time;

FIGS. 7A and 7B show experimental results during operation of a lamp having electrodes of different sizes, and an electric potential distribution at that time;

FIG. 8 shows an outline of manufacturing steps for a glass bulb of embodiment 2;

FIGS. 9A and 9B show bead glass in a state of being fixed to a glass tube in a variation, FIG. 9A being a longitudinal sectional view of a fixed portion of the bead glass, and FIG. 9B being a transverse sectional view of the fixed portion of the bead glass;

FIG. 10 is a longitudinal sectional view of a sealed part; and

FIG. 11 shows experimental results of measuring a relationship between luminance variation and variation between electrode capacitor capacitances.

### DESCRIPTION OF THE CHARACTERS

1 backlight unit
10 lamp
11 glass tube
14 discharge space
15 glass bulb
18, 19 electrode
100 glass tube
102, 112 sealed part
200 bead glass
210 through-hole
212 end face
500 glass tube
552, 556 sealed part
522, 524 bead glass
523, 525 through hole

### BEST MODE FOR CARRYING OUT THE INVENTION

Below is a description of a backlight unit using an external-electrode discharge lamp (hereinafter, simply “lamp”) of the present invention, followed by a description of the lamp and a manufacturing method for the lamp. Note that specifications of the lamp described hereinafter, such as measurements, capacitor capacitances, and the like, are exemplary, and the present invention is not limited to these specifications.

1. Outline of a Structure of a Backlight Unit

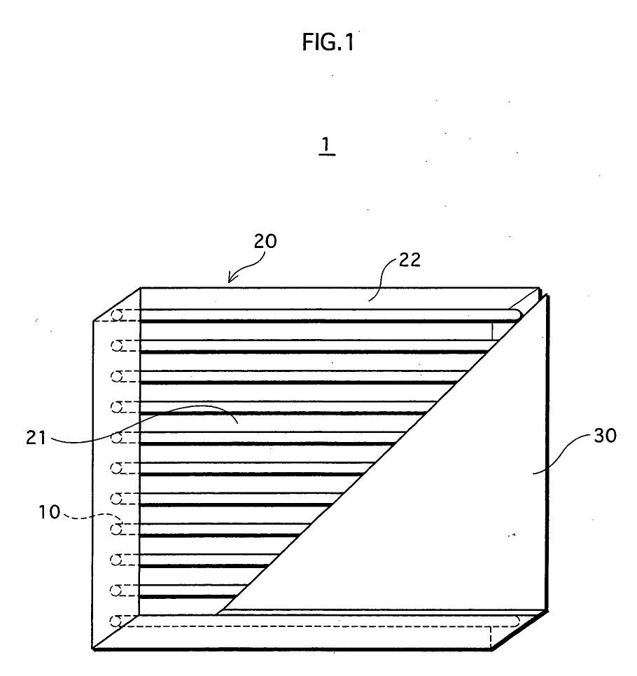

FIG. 1 is a schematic perspective view of a backlight unit, with a part of a front face cut out to show an interior of the backlight unit. Here, “front” refers to a screen side when the backlight unit has been incorporated in a display.

As shown in FIG. 1, a backlight unit 1 includes straight-tube lamps 10 arranged in a plurality of rows at intervals in a predetermined direction (here, the vertical direction), a case 20 storing the lamps 10, and a diffuser 30 covering an opening of the case 20.

The case 20 is composed of a bottom plate 21 and side plates 22 standing on a periphery of the bottom plate 21, and is constituted from, for example, a metallic material (iron). Note that the bottom plate 21 is, for example, given a mirror finish so as to reflect light emitted from the lamps 10 on the back side to the front side.

The lamps 10 use dielectric barrier discharges, and, in the present embodiment, are arranged in a horizontal direction and electrically connected in parallel. Note that although the lamps 10 are arranged here such that main axes thereof are in the horizontal direction, the main axes may be arranged in the vertical direction.

The diffuser 30 is for diffusing light from the arranged lamps 10 to reduce luminance variation on the display screen, and is constituted from, for example, acrylic.

2. Structure of the Lamps

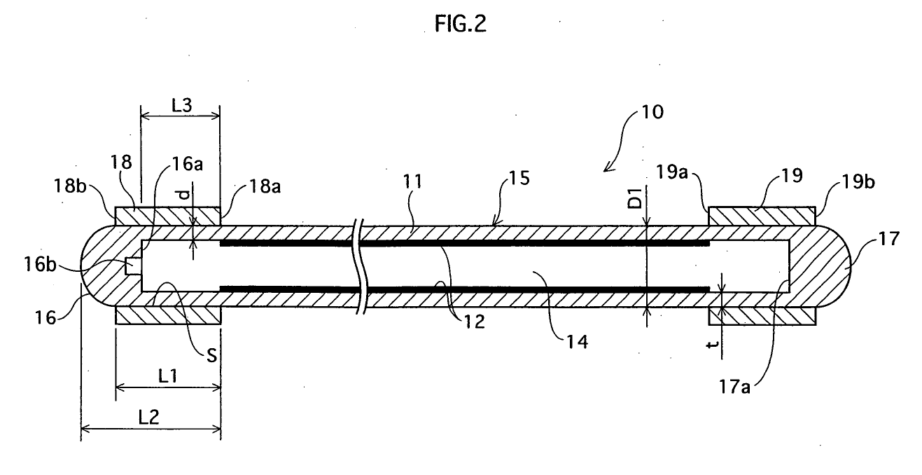

FIG. 2 is a longitudinal sectional view of the lamp pertaining to the present embodiment.

The lamp 10 includes a glass-bulb 15 composed of a glass tube 11 whose ends are sealed, and electrodes 18 and 19 which are provided around outer circumferential peripheries of the ends of the glass bulb 15 in the axial direction. A transverse cross-section of the glass tube 11 is circular in shape, and a phosphor layer (e.g., including a three-band phosphor) 12 is formed on an inner circumferential surface of the glass tube 11.

Also, a discharge medium such as mercury and/or rare gases (e.g., argon or neon) is enclosed at a predetermined enclosure pressure in a discharge space 14 formed in the glass tube 11 whose ends are sealed. Note that as mentioned above, the discharge medium is filled into the decompressed discharge space, that is, in the glass tube 11 at a reduced pressure.

The glass bulb 15 results from having the discharge medium filled into the discharge space 14 within the glass tube 11 whose ends have been sealed. Also, the sealed portions are called sealed parts 16 and 17.

The glass tube 11 is, for example, a borosilicate glass tube, and has an outer diameter of approximately 4 mm and an inner diameter of approximately 3 mm. Note that the overall length of the lamp 10 is 720 mm. The glass tube 11 is sealed by, for example, using gas burners to apply heat and melt the ends.

After sealing the glass tube 11, the shapes of the inner circumferential surfaces of the ends are substantially the same. To be precise, a portion 16a of the sealed end 16 facing the discharge space 14 has a depression 16b extending toward the end of the glass bulb 15. Conversely, a portion protruding into the discharge space 14 on the portion 16a would result in a loss to the discharge space. However, a depression 16b extending away from the discharge-space 14 (toward the end of the glass bulb 15) does not result in a loss to the discharge space, and it is possible to view the shapes of the portions 16a and 17a of the sealed ends 16 and 17 facing the discharge space 14 as substantially the same. Note that a method of sealing the ends of the glass tube 11 and the like is mentioned hereinafter.

The electrodes 18 and 19 are formed by, for example, applying a silver paste around an entire circumference of electrode formation portions of the glass bulb 15. In the present embodiment, a width L1 of the electrodes 18 and 19 is 21 mm.

At this time, a distance L2 between respective ends of the glass bulb 15 and end faces 18a and 19a toward the center of the glass bulb 15 (that is, inner end faces of the electrodes 18 and 19) is 23 mm, and a distance L3 between respective inner end faces 18a and 19a and the portions 16a and 17a is 20 mm.

During operation of the lamp 10, the electrodes 18 and 19, and the glass tube 11 lying between the discharge space 14 and the electrodes 18 and 19 equivalently function as first and second capacitors (see Japanese Patent Application Publication No. 2003-229092).

There is the following relationship between the capacitances of the capacitors corresponding to the electrodes 18 and 19 (hereinafter, the capacitances are referred to as simply “electrode capacitor capacitances”) “C”, a dielectric constant of the glass tube 11 “∈”, a thickness of the glass tube 11 “d”, and an effective area of the electrodes. “S” (see FIG. 2).

C=∈*S/d

Note that the “effective area of the electrodes” is the area of portions where the discharge space 14 of the glass bulb 15, and the electrodes 18 and 19 overlap in the diameter direction, which described using FIG. 2 is as follows.

S=π*D1*L3

In the lamp 10 of the present invention, the effective areas S of the electrodes 18 and 19 are equal since the shapes of the inner circumferential surfaces of the ends of the glass bulb 15 (that is, the shapes of the portions 16a and 17a which face the discharge space 14) are substantially the same, thereby enabling the capacitor capacitances C of the electrodes 18 and 19 to be substantially equal.

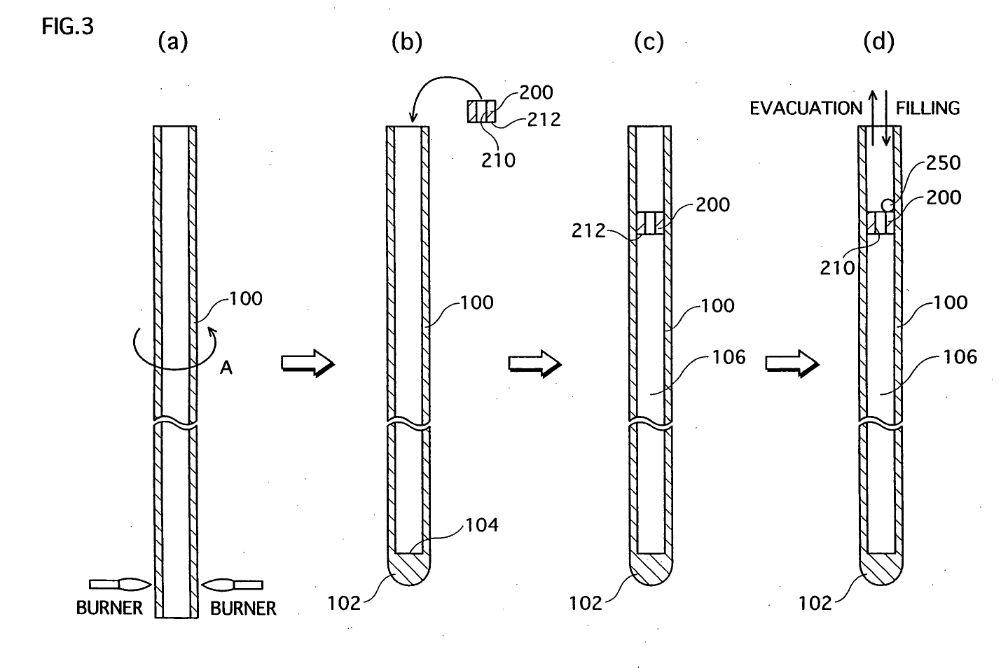

In conventional manufacturing methods, however, one end is sealed, a negative pressure is maintained in the glass tube, and the other end is then sealed using a tip-off method. For this reason, the second end is open when sealing the first end, thereby making it possible to give the sealed portion of the first end a desired shape. However, when sealing the other end, the wall of the softened glass tube end is sucked in due to the negative pressure inside the glass tube, for instance, the portion corresponding to the end face of the discharge space irregularly buckles along the tube axis of the glass tube into the shape of, for example, the ends of the glass bulb in FIG. 3 of Japanese Patent Application Publication No. H5-114387. As a result, the shapes of the sealed portions and the thickness of the glass tube differ with a conventional glass bulb.

For this reason, there is a large difference between the effective areas of the electrodes at the ends of the glass bulb, as well as large differences in the thickness of portions of the glass tube corresponding to the electrodes, thereby resulting in a large difference between the electrode capacitor capacitances. The inventors attempted to tip-off seal the ends of the glass tube and make the shapes of the sealed portions at both ends substantially the same, but sealed portions with substantially the same shape could not be obtained. Note that the effect of the shape of the sealed portions on capacitance is reduced if the electrodes are provided toward the center of the glass bulb, and the electrode capacitor capacitances can be made substantially the same, but the lamp must be lengthened in order to maintain a predetermined inter-electrode distance.

The following is a specific description of the electrodes. The thickness d of the glass bulb 15 (glass tube 11) is approximately 0.5 mm, the dielectric constant ∈ of the glass tube 11 (here, the dielectric constant is a ratio with respect to the dielectric constant in a vacuum) is approximately 6.9, the effective areas S of the electrodes 18 and 0.19 are 251 mm², and the capacitances of the electrodes 18 and 19 are approximately 30.5 pF. Note that the difference between the capacitor capacitances C of the electrodes is approximately 3 pF.

Although the width, position, etc. of the electrodes 18 and 19 are determined according to the measurements of the glass tube 11 (the glass bulb 15) and the amount of light to be emitted, it is desirable to have outer end faces 18b and 19b of the electrodes 18 and 19 be positioned more outward than the portions 16a and 17a facing the discharge space 14.

In the case of using lamps of the same length and electrodes with the same width, if the outer ends of the electrodes are positioned inward of the sealed portions ends on the discharge space side, the distance between the electrodes will become that much shorter, that is, the effective light-emitting length of the lamp will be shortened, and the luminous flux that can be emitted from the lamps will be reduced.

Also, while light converted by the phosphor layer is emitted outside the lamp, an increasing amount of light will be blocked by the electrodes the more the electrodes are positioned inward with respect to the lamp. Also, light will be emitted from any of the discharge space positioned more outward than the electrodes. Given that this discharge space would correspond to a portion for mounting to the backlight unit, an illumination apparatus or the like, light emitted from this space would not normally be used, thereby resulting in a reduction of the luminous flux emitted by the whole of the lamp.

Consequently, the portions of the glass bulb from the electrode portions to the outward ends of the lamp are, as mentioned above, portions that do not contribute to the light emittance of the lamp, and there is little influence on the light emitting properties even if the outer ends of the electrodes are extended to these portions. If the electrodes are made to extend further toward the ends of the glass bulb in this way, there will be a greater contact area between the electrodes and a supply terminal that supplies power to the lamp. This obtains effects such as an improved electrical connection with the supply terminal when the lamp is mounted in a backlight unit.

When the capacitor capacitances of the electrodes 18 and 19 are substantially matched as mentioned above, the luminance of the operated lamp 10 at both ends is equal, and luminance variation can be suppressed (the lamp 10 with the above structure has also been checked using a lighting test).

The reason for this is mentioned hereinafter, but after various examinations the inventors found that the reason for the increasing luminance variation lies in an unevenness of mercury in the glass bulb (cataphoresis effect), and this cataphoresis effect ultimately occurs as a result of variation between the electrode capacitor capacitances.

3. Manufacturing Method of the Lamp

Next is a description of a manufacturing method for the lamp 10, and in particular a manufacturing method for the glass bulb 15. Note that the electrodes 18 and 19 provided around the ends of the glass bulb 15 are the same as in conventional technology, and descriptions thereof are omitted.

A glass bulb with the above structure is manufactured by a sealing step of tip-off sealing one end of the glass tube constituting the glass bulb, a bead glass fixing step of fixing bead glass having a through hole to the other end of the glass tube at a position intended for sealing, an evacuation/filling step of decompressing the interior of the glass tube and filling the discharge medium through the through hole of the bead glass, a tentative sealing step of tentatively sealing the glass tube filled with the discharge medium by tip-off sealing at a site more outward than the position where the bead glass was fixed, and a plugging step of plugging the through hole of the bead glass.

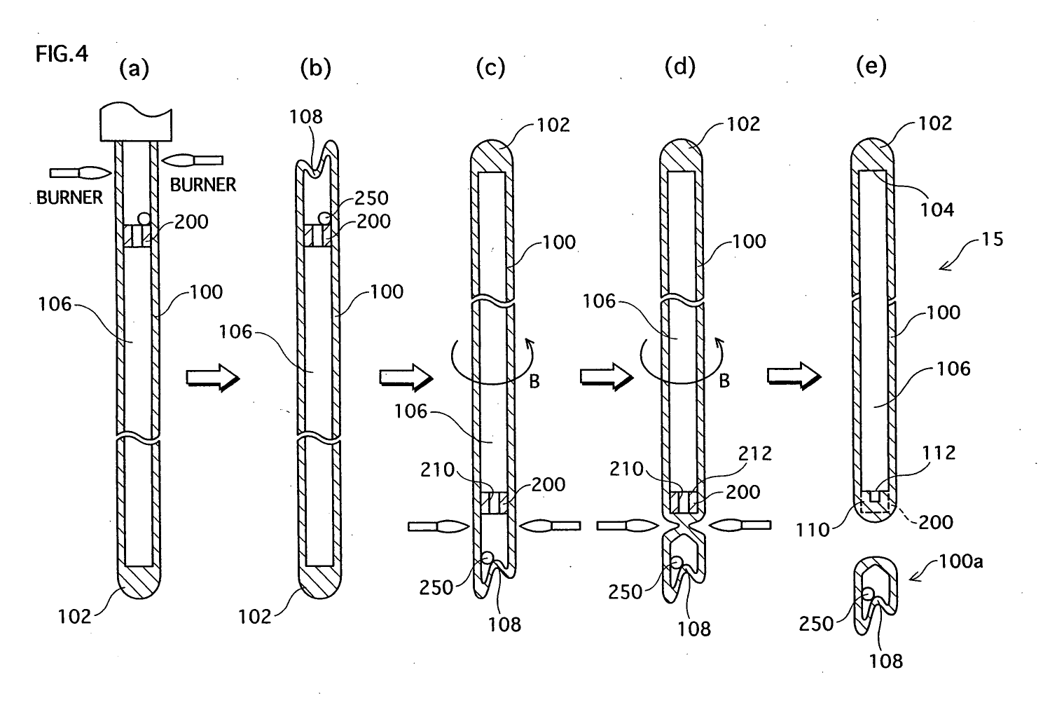

Next is a description of the steps, using FIGS. 3 and 4. Note that this is a description of a case of using a glass tube 100 to manufacture the glass bulb 15 having the exemplary measurements in the description of the structure of the above-mentioned lamp 10.

(1) Sealing Step

First, there is provided the glass tube 100 having, predetermined measurements of, for example, an outer diameter of 4 mm, an inner diameter of 3 mm, and a length of 800 mm. Although not depicted, a phosphor 12 is applied to a predetermined range of an inner circumferential surface of the glass tube 100.

The glass tube 100 is then stood substantially vertical. As shown in (a) of FIG. 3, gas burners, for example, are used to apply heat to a portion slightly upward of the bottom end of the glass tube 100 (corresponding to a second site of the present invention), which, here, is a site 2 mm upward from the bottom end. As shown in (b) of FIG. 3, the bottom end portion of the glass tube 100 is tip-off sealed. The sealed portion is called a sealed portion 102 and corresponds to the sealed portion 17 of the completed glass bulb 15 shown in FIG. 2.

During tip-off sealing, the glass tube 100 is rotated, with the rotation axis being the tube axis (the direction of arrow A in (a) of FIG. 3), in order to make an inner circumferential end face 104 of the sealed portion 102 substantially flat and give the outer circumferential end face a hemispherical shape.

The end face 104 of the sealed portion 102 is flattened as follows. Specifically, during tip-off sealing, a nitride gas, for example, is filled into the glass tube 100 through an aperture of a top end thereof to somewhat pressurize the interior of the glass tube 100, and a flat end face is obtained by stopping the application of heat by the gas burners when the end face 104 becomes flat.

Also, when the tube walls of the heat-softened glass tube 100 join together during sealing, a remaining portion is cut off at a position below the joined portion toward the end of the glass tube. Cutting off the remaining portion enables the suppression of leaks in the sealed part 17 of the post-manufacture glass bulb 15. For reference, if a leak were to occur in the sealed part 17, the discharge medium filled in the discharge space 14 would leak out, the emitted light luminous flux would be reduced, and the lamp would eventually fail to light.

Note that there are methods other than as mentioned above for suppressing leaks in the sealed part, such as a method of lengthening the amount of time heat is applied to the sealed part, and when the softened tube walls of the glass tube have joined together, touching another glass tube to the joined portion and then pulling a little.

(2) Bead Glass Fixing Step

Next, there is provided bead glass (corresponding to an insert of the present invention) 200 which can be inserted into the glass tube 100. The bead glass 200 is of the same material as the glass tube 100 (borosilicate glass), is cylindrical in shape, and includes a through hole 210 at a substantially central position and extending in the tube axis direction. Also, an end face 212 of the bead glass 200 is flat. Note that the bead glass 200 has measurements which are an outer diameter of 2.7 mm, an inner diameter of 1.05 mm, and a length of 2.0 mm.

As shown in (c) of FIG. 3, the bead glass 200 is inserted to a predetermined position (corresponding to a first site of the present invention) of the glass tube 100 such that the through hole 210 is substantially parallel with the tube axis of the glass tube 100, and fixed at the predetermined position. The predetermined position is the sealing position of the glass tube 11 in FIG. 2, which is 80 mm downward from the top end of the glass tube 100.

Although not depicted, the bead glass 200 is fixed by, for example, inserting the bead glass 200 into the glass tube 100 which is in a horizontal state, applying heat to the glass tube 100 in the vicinity of the inserted bead glass 200 to fuse an entirety of the outer circumferential surface of the bead glass 200 and the inner circumferential surface of the glass tube 100.

Note that even though a part of the glass tube 100 is heated in the fixing step for the bead glass 200, the softened part does not excessively buckle since the interior of the glass tube 100 is not depressurized.

(3) Depressurization/Filling Step

Next, an amalgamate mercury body 250 is disposed on an upper surface of the bead glass 200 in the glass tube 100 so as to not block the through hole 210 of the bead glass 200. As shown in (d) of FIG. 3, rare gases or the like are filled into the glass tube 100 after the glass tube 100 has been evacuated and depressurized.

As a result, the filled rare gases and the mercury (more precisely, the amalgamate mercury body) are enclosed in a space 106 between the bead glass 200 and the sealed part 102 (This space corresponds to the discharge space 14 of the completed glass bulb 15, and is called a “pre-sealing discharge space”.) in the glass tube 100.

Note that rare gases (argon and neon) are filled to approximately 8 kPa. Also, the interior of the glass tube 100 is at a negative pressure with respect to the atmosphere.

(4) Tentative Sealing Step

Upon completing the evacuation/filling step, the discharge medium is maintained in the pre-sealing discharge space 106, and, as shown in (a) of FIG. 4, the glass tube 100 is tentatively tip-off sealed by using gas burners to apply heat to a portion (at the end opposite of the sealed part 102) upward of the fixing portion of the bead glass 200, which, here, is 30 mm upward from the top end of the bead glass 200.

When the portion to be sealed is heated and softened by the gas burners, the tube walls of the glass tube 100 are sucked in due to the fact that the interior of the glass tube 100 is depressurized during tentative sealing, and an end face of a tentatively sealed part 108 buckles to a shape as shown in (b) of FIG. 4.

Next, heat is applied to the vicinity of the mercury body 250 in the glass tube 100 to evaporate mercury from the mercury body 250, and the evaporated mercury is filled into the pre-sealing discharge space 106 through the through hole 210 of the bead glass 200. This completes the filling of the rare gases and the mercury into the pre-sealing discharge space 106. Note that approximately 2 mg of mercury is filled into the pre-sealing discharge space 106.

(5) Plugging Step

Upon completion of the tentative sealing step, and as shown in (c) of FIG. 4, the glass tube 100 is inverted from top to bottom, and gas burners are used to heat the portion of the glass tube 100 below the bead glass 200 in order to heat the tube walls of the corresponding portion.

Upon removing the tentatively sealed part 108 of the glass tube 100 (the removed portion is indicated by the notation “100a” in (e) of FIG. 4), and as shown in (d) of FIG. 4, the melted glass material covering the through hole 210 of the bead glass 200 is sucked into the glass tube 100 via the through hole 210, thereby plugging the through hole 210.

The depression 16b shown in FIG. 2 is formed at this time when the glass material is sucked partway into the through hole 210. A depression is not formed if the glass material reaches the end of the through hole 210 (i.e., the end face of the bead glass 200).

As a result, the sealed part 110 which is opposite of the sealed part 102 of the glass tube 100 is formed, and manufacturing of the glass bulb 15 is complete. Although the bead glass 200 has been integrated with the end of the glass tube 100 at the sealed part 110, the bead glass 200 is indicated by a dashed line in (e) of FIG. 4 so as to be discernible.

Note that the glass tube 100 is rotated in the plugging step such that the bottom end periphery of the bead glass 200 melts evenly along a circumference thereof.

With the glass bulb 15 manufactured according to the above steps, the glass melted when fixing the bead glass 200 is not deformed since the bead glass 200 is fixed while the interior of the glass tube 100 is not in a depressurized state.

Also, as shown in (e) of FIG. 4, end faces 104 and 112 are flat with respect to each other, and have substantially the same shape. These end faces 104 and 112 of the sealed parts 102 and 110 respectively are on the inward side of the glass tube 110 (corresponding to the portions 16a and 17a, in FIG. 2, pertaining to the sealed parts 16 and 17 respectively of the glass bulb 15 and facing the discharge space 14). While the tube diameter of the glass tube 100 of course differs slightly, the measurements and shapes of the inner circumferential surfaces of the sealed parts 102 and 110 are substantially equal.

4. Regarding the Occurrence of Luminance Variation

Upon performing various examinations on why there is a large amount of luminance variation at the ends of conventional lamps during use, the inventors found that, with a center of the lamp in the longitudinal direction as a reference, the electric potential distributions at the ends of the lamp differ if the capacitor capacitances of the electrodes at the ends differ during operation of the lamp.

This result was found by performing an experiment in which a lamp, using a glass bulb which has ends of the same shape and is provided with electrodes of different sizes, was actually manufactured and operated, and the voltage levels of the electrodes were measured.

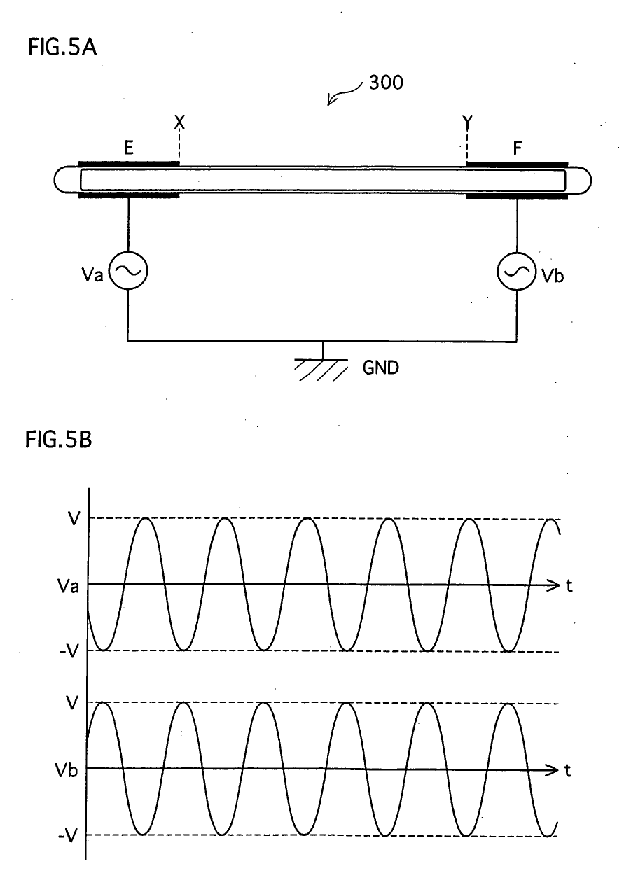

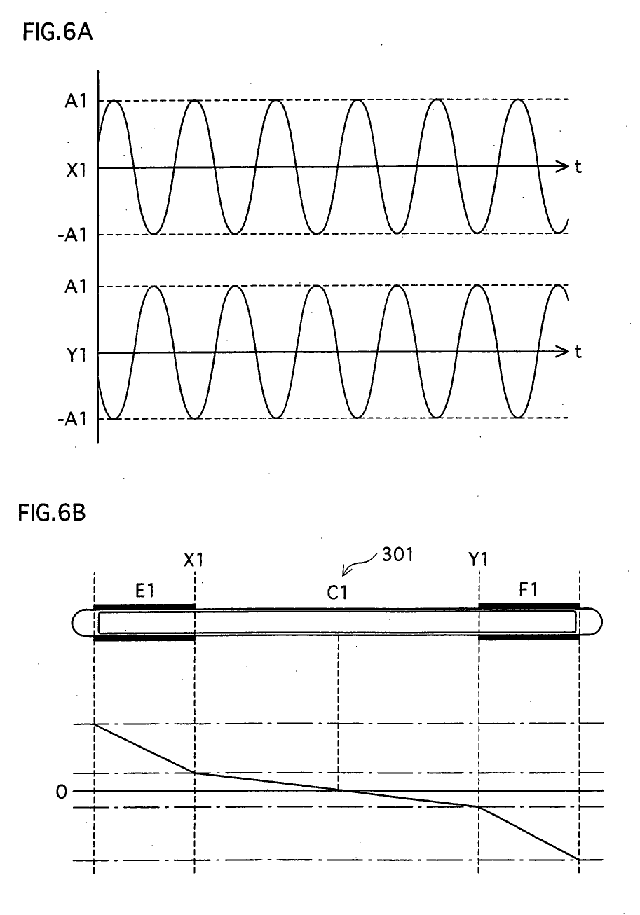

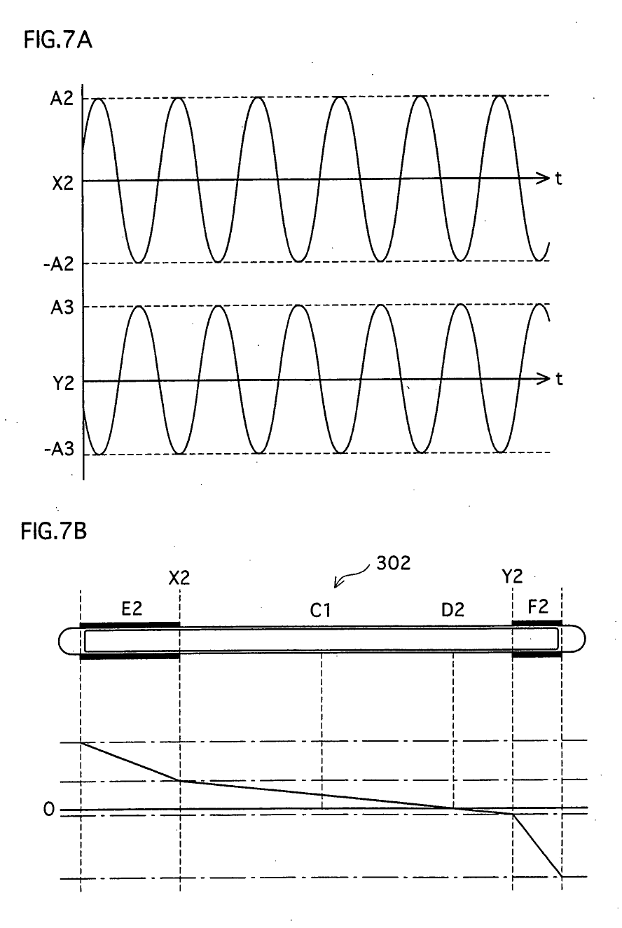

FIGS. 5A and 5B show an overview of the experiment measuring the voltage levels. Also, FIGS. 6A and 6B show experimental results during operation of a lamp with electrodes of substantially the same size, and the electrical potential distribution at that time. FIGS. 7A and 7B show experimental results during operation of a lamp with electrodes of different sizes, and the electrical potential distribution at that time.

First is a description of conditions when lighting the lamp.

As shown in FIG. 5A, electrodes E and F of a lamp 300 are connected to AC (alternating current) voltage sources Va and Vb, which are connected to GND.

The lamps used in the experiment include glass bulbs obtained using the manufacturing method of the present invention. In other words, the shapes of the inner surfaces of the ends of the glass bulb and contacting the discharge space are the same, but in one of the lamps the sizes of the electrodes at the ends are the same (i.e., the lamp pertaining to the present invention, and indicated by the notation “301”), and in the other lamp the sizes of the electrodes at the ends are different (i.e., corresponding to a conventional lamp, and indicated by the notation “302”). For this reason, the different sizes of the electrodes result in the different electrode capacitor capacitances. Note that the thickness of the glass bulbs is the same for both lamps.

As shown in FIG. 5B, the AC voltages applied to the electrodes E and F have the same amplitude (indicated by “V” in the figure), the same frequency, and are phase shifted 180 degrees. As shown in FIG. 5B, voltages at ends X and Y on the inner sides of the electrodes E and F with respect to the longitudinal direction of the lamp (hereinafter, simply “inner ends”) were measured during operation of the lamp 300.

(1) Case of the Electrodes having the Same Size

FIG. 6A shows the results of measuring the voltages at inner ends X1 and Y1 of electrodes E1 and F1 with respect to the longitudinal direction of a lamp 301, during operation of the lamp 301.

It is evident from this figure that although the voltages at inner ends X1 and Y1 of the electrodes E1 and F1 are in opposite phase, amplitudes A1 are the same, and the frequencies are also the same. It is possible to infer from this that, as shown in FIG. 6B, the potential acting in the lamp 301 is 0 V at a central position C1 in the longitudinal direction of the lamp 301, and the potentials on both sides of the central position C1 are symmetric with respect to the central position C1. In FIG. 6B, the vertical axis indicates potential V, and the horizontal axis indicates the distance from an outer end of the electrode E1 with respect to the longitudinal direction of the lamp (hereinafter, simply “outer end”) to an outer end of the electrode F1.

(2) Case of the Electrodes having Differing Sizes

FIG. 7A shows the result of measuring the voltages at inner ends X2 and Y2 of electrodes E2 and F2 with respect to the longitudinal direction of a lamp 302, during operation of the lamp 302. Note that as is clear in FIG. 7B, the electrode E2 is larger than the electrode F2, and a capacitor capacitance of the electrode E2 is larger than a capacitor capacitance of the electrode F2.

It is evident from the figure that the voltages at the inner ends X2 and Y2 of the electrodes E2 and F2 are in opposite phase and have the same frequency, similarly to during operation of the above-mentioned lamp 301, but the amplitudes are different. Specifically, there occurs the following relationship between amplitude A2 of the voltage near the electrode E2 at the inner end X2, and amplitude A3 of the voltage near the electrode F2 at the inner end Y2.

A3<A2

It is possible to infer from this that, as shown in FIG. 7B, the potential acting in the lamp 302 is 0 V at a position D2 which is, compared with the central position C1, shifted toward the electrode F2 in the longitudinal direction of the lamp 302.

(3) Conclusion

In general, the internal temperature of a lamp is related to the potential at different portions of the lamp, and the temperature tends to be lower where the potential is 0 V. The potential is 0 V at the substantially central position C1 in the lamp 301 with electrodes of the same size. Also, in the lamp 302 with electrodes of differing sizes, the potential is 0 V at the position D2 which is shifted from the central position C1 of the lamp 302 toward the electrode with the smaller capacitor capacitance (here, corresponding to the electrode F2).

The temperature near the electrodes is also related to the capacitor capacitances. Given that the capacitor capacitances of the lamp 301 whose electrodes are the same size are equal, the temperatures near both the electrodes are substantially the same, the position in the lamp 301 where the temperature is lower is at the substantially central position C1, and, furthermore, a temperature distribution of the lamp 301 is substantially symmetric with respect to the central position C1. Also, given that there are different capacitor capacitances in the lamp 302 whose electrodes have different sizes, the temperatures near the electrodes are not equal, the position in the lamp 302 where the temperature is lowered is not at the central position C1, and, furthermore, a temperature distribution of the lamp 302 is not symmetric with respect to the central position C1.

Also, mercury has a characteristic of gathering toward an area of lower temperature. It is evident from this that the mercury in the lamp 301 whose electrodes are the same size gathers to the substantially central position C1, and a distribution of the mercury is substantially symmetrical (equal) at the ends with respect to the central position C1. In contrast, the mercury in the lamp 302 whose electrodes have different sizes gathers to a position shifted away from the substantially central position C1, and a distribution of the mercury is asymmetrical (different) at the ends with respect to the central position C1. In other words, a cataphoresis effect is occurring in the lamp 302.

Here, the inventors considered that with the lamp 301 in which the mercury gathers to the substantially central position C1 with respect to the longitudinal direction of the lamp (i.e., the lamp (301) whose electrode capacitor capacitances are the same), the distribution of mercury is substantially the same on both sides of the central position C1 as a reference, and it is possible to suppress the occurrence of luminance variation. Also, the inventors considered that with the lamp 302 in which the mercury gathers to the position D2 that is shifted from the central position C1 toward one of the electrodes (here, the electrode F2) (i.e., the lamp whose electrodes E2 and F2 have different capacitor capacitances), the distribution of mercury is different on both sides of the central position C1 as a reference, and luminance variation increases as a result of the cataphoresis effect.

In other words, the inventors arrived at the conclusion that the reason for the increasing luminance variation lies in differences (variations) between the capacitor capacitances of electrodes A and B at the ends of the lamp. Note that the electric potential distributions shown in FIGS. 6B and 7B are conceptual, and do not consider phase contrast in the capacitors, and the like.

### Embodiment 2

Whereas the case of sealing one end (corresponding to the first site of the present invention), then sealing the other end (corresponding to the second site of the present invention) of the glass tube 100 in the lamp 10 of the above embodiment 1 has been described, the present embodiment describes a case of sealing both ends of the glass tube (the first site and the second site) at substantially the same time.

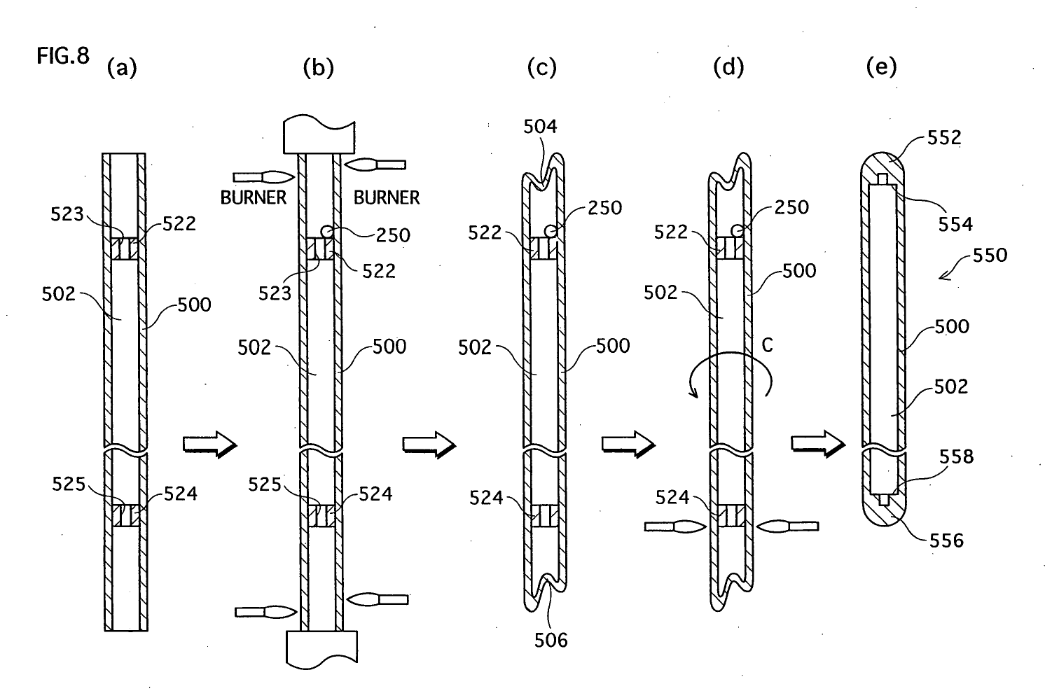

FIG. 8 shows a manufacturing method for a glass bulb of embodiment 2.

In the present embodiment, bead glass 522 and 524 are first fixed, as shown in (a) of FIG. 8, to positions (corresponding to the first and second sites of the present invention) associated with sealed parts 16 and 17 of a glass bulb 15 pertaining to a glass tube 500.

Note that the bead glass 522 and 524 are the same as the bead glass 200 described in embodiment 1, include through holes 523 and 525 respectively, and are fixed using, for example, the method described in embodiment 1.

Next, a pre-sealing discharge space 502 of the glass tube 500 is evacuated and depressurized, a discharge medium is filled therein, and while maintaining this state, as shown in (b) of FIG. 8, portions of the glass tube 500 outward from the positions where the bead glass 522 and 524 were fixed are tip-off sealed using gas burners. As shown in (c) of FIG. 8, this results in the ends of the glass tube 500 being tentatively sealed. The tentatively sealed portions are called tentatively sealed parts 504 and 506.

Also, the through holes 523 and 525 of the bead glass 522 and 524 are plugged by removing the tentatively sealed parts 504 and 506 using, for example, the same method as is described in the plugging step of embodiment 1. As shown in (e) of FIG. 8, this results in the formation of the sealed parts 552 and 556, as well as the completion of a glass bulb 550.

It is possible to precisely match the shapes of end faces 554 and 558 of an inner circumference of ends 552 and 556 pertaining to the glass bulb 550, if the shapes of the facing surfaces of the bead glass 522 and 524 are the same when using the bead glass 522 and 524 to seal the ends of the glass tube 500, as in the present embodiment.

Variations

Although having been described based on the embodiments, the content of the present invention is of course not limited to the specific examples shown in the above embodiments. For example, variations such as the following may also be implemented.

1. Method for Controlling Luminance Variation

By performing various examinations, the inventors found that the reason for luminance variation between the ends of the lamp lies in the difference between the electrode capacitor capacitances. First, the inventors examined giving the substantially same shape to the inner circumferential surfaces of the ends of the glass bulb, such that the effective areas of the electrodes proportional to the capacitor capacitances are substantially the same, and invented the manufacturing method described in the above embodiments.

However, the inventors found it is possible to match the electrode capacitor capacitances to suppress luminance variation using methods other than the manufacturing method described in the embodiments.

(1) Regarding the Electrodes

For example, the width of the electrodes may be appropriately determined in accordance with the shapes of the inner circumferential surfaces of the glass tube to make the effectives areas of the electrodes substantially the same. More specifically, as shown in FIG. 2, the electrode width L1 or the distance L2 from the inner ends of the electrodes to the respective tube end surfaces may be changed.

Note that the case of changing the electrode width L1 can be implemented without influencing the light emission of the lamp, if the electrode width L1 is made longer in advance, and a portion of the electrode toward the end of the glass bulb is removed.

(2) Regarding the Dielectric Constant

Although electrodes are provided directly on the outer circumferential surface of the glass bulb in the embodiments, the electrode capacitor capacitances may be made substantially the same by, for example, forming an insulation layer between the glass tube and the electrodes to change the dielectric constant. A resin material may be used as the insulation layer, and the present variation may be implemented by, for example, applying the resin before it has hardened, immersing the ends of the glass tube in the resin, or affixing a resin film in a half-hardened state to the glass tube.

2. Regarding the Lamp

Although a direct-type backlight unit has been described as an exemplary application of the lamp pertaining to the present invention, the lamp may of course also be applied in a light-guiding-plate backlight unit. In this case, the glass tube may be curved into a “U” shape or an “L” shape. The lamp of the present invention can also be used as a light source in a general illumination apparatus.

3. Regarding the Electrodes

Although the electrodes are formed in the embodiments by applying a conductive silver paste, the present invention is not limited to this. For example, the electrodes may be formed by conductive tape.

Also, although the electrodes are formed around the outer circumference of the glass tube, that is, continuously in the circumferential direction, the effective areas of the electrodes may be adjusted by forming the electrodes intermittently. In this case, however, only the electrode portions have an effect on the electrode capacitor capacitances.

Note that although constituted from a single electrode part in the embodiments, each of the electrodes may be constituted from, for example, two or more electrode parts. In other words, the electrodes may have two or more electrode parts, and these electrode parts may be disposed in parallel in the axis direction of the glass tube. The capacitances may be made substantially equal by adjusting a contact area between one of the electrode parts and the glass tube.

Furthermore, although constituted from a single material (specifically, a silver paste) in the embodiments, each of the electrodes may be constituted from two or more materials. For example, an electrode may have a first electrode part composed of a first material and a second electrode part composed of a second material, and the first and second electrode parts may be disposed in parallel in the axis direction of the glass tube. The capacitances may be made substantially equal by adjusting the contact area between one of the electrode parts and the glass tube.

4. Regarding Bead Glass

(1) Overall Shape

Although the bead glass is cylindrical and has a substantially centered through hole in the above embodiments, the bead glass may be another shape. For example, one end face of the bead glass in the embodiments may be hemispherical. In this case, it is possible to easily give the outer end face of the bead glass a hemispherical shape after plugging the through hole.

(2) Regarding the Through Holes

In the embodiments, an entirety of the outer circumferential surface of the bead glass 200 and the inner circumferential surface of the glass tube 100 are fused. However, if for example the bead glass 200 and the glass tube 100 are partially fused, and a link is provided such that the space in the glass tube 100 inward of the bead glass 200 and the space outward of the bead glass 200 are linked, the discharge medium can be filled into the space inward of the bead glass 200 without providing a through hole therein, and, similarly to the embodiments, the inner circumferential surfaces of the ends of the glass bulb 15 can be given substantially the same shape.

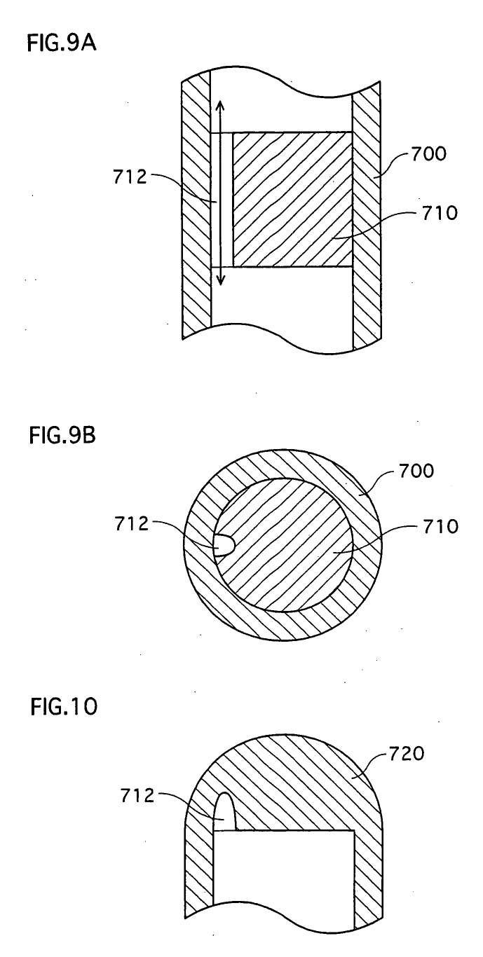

FIGS. 9A and 9B show bead glass in a state of being fixed to the glass tube in the present variation, where FIG. 9A is a longitudinal sectional view of a fixed portion of the bead glass, and FIG. 9B is a transverse sectional view of the fixed portion of the bead glass. Also, FIG. 10 is a longitudinal sectional view of a sealed part in the present variation.

An outer circumferential surface of bead glass 710 includes a groove 712 extending in the axis center direction, and the bead glass 710 is fixed to a glass tube 700 such that the groove 712 is not obstructed. An end 720 of the glass tube 700 is sealed as shown in FIG. 10 by tentatively sealing a portion of the glass tube 700 outward from the bead glass 710, and then plugging the groove 712. Note that it would be necessary to heat an edge of the bead glass 710 on the discharge space side in order to completely fill in the groove 712.

(3) Material

Although the bead glass 200, 522 and 524 which are of the same material as the glass tubes 100 and 500 are used as inserts in the above embodiments, the inserts of the present invention are not limited to bead glass. It is sufficient to use a glass material that has roughly the same heat expansion coefficient as the glass tube, so there is no problem of reliability in terms of a leak in the sealed part.

Although constituted from a metallic material in the above embodiments, the case of the backlight unit may be constituted from an other material. The other material may be, for example, a resin material such as polyethylene terephthalate (PET). Needless to say, another resin material may of course be used.

5. Regarding Luminance Variation

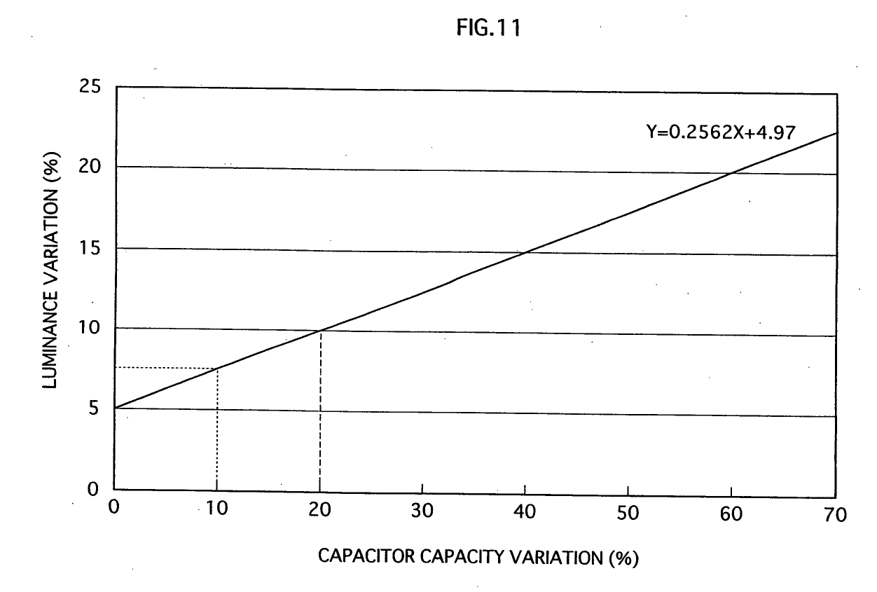

Although the variation between the capacitor capacitances of the electrodes at the ends of the glass bulb 15 is approximately 9.8% in the above embodiment 1, this variation need only be within 10% of the value of the smaller capacitor capacitance. This is because the human eye cannot perceive luminance variation that occurs when the variation between capacitor capacitances is within 10% (in FIG. 11 which is mentioned hereinafter, the luminance variation at this time is within 7.5%).

Furthermore, for example, lamps used in backlight units are often used together with a diffuser, and there is no problem with actual use in this case as long as the luminance variation of the lamps does not exceed roughly 10%. As described below, luminance variation is within 10% if the variation between the capacitor capacitances is within 20%.

The following describes why it is sufficient for the variation between the capacitor capacitances to be within 20%.

FIG. 11 shows experimental results of measuring a relationship between variations in electrode capacitor capacitance and luminance variation. Note that a variation between electrode capacitor capacitances is displayed as “capacitor capacitance variation”.

The capacitor capacitance variation is calculated from a maximum capacitor capacitance C1 of the larger electrode, and a minimum capacitor capacitance C2 of the smaller electrode, as shown below.

capacitor capacitance variation=(maximum capacitor capacitance C1−minimum capacitor capacitance C2)/minimum capacitor capacitance C2

Similarly, luminance variation is calculated from a maximum luminance 11 near the brightest place during operation of the lamp, and a minimum luminance 12 near the darkest place during operation of the lamp, as shown below.

luminance variation(maximum luminance 11−minimum luminance 12)/minimum luminance 12

As shown in FIG. 11, there is a substantially linear relationship between the luminance variation of the lamp and the capacitor capacitance variation, which is expressed by the following, where Y is the luminance variation of the lamp, and X is the capacitor capacitance variation.

Y=0.2562*X+4.97

It is also evident from FIG. 11 that the capacitor capacitance variation is 20% or less when the luminance variation of the lamp is within 10%. Note that if, for example, the capacitor capacitance variation is made 10% or less, it is possible to reduce the luminance variation of the lamp to within 7.5%, and further improve quality when used in a backlight.

6. Depressurization/Filling Step

At the outset of the depressurization step in the above embodiments, that is, before depressurizing the interiors of the glass tubes 100 and 500, the mercury body 250 is disposed inside the glass tubes 100 and 500, and the mercury is filled into the pre-sealing discharge spaces 106 and 502 before plugging the through holes 210, 523 and 525 of the bead glass 200, 522 and 524 respectively.

However, the mercury may be filled into the pre-sealing discharge space before tentatively sealing the ends of the glass tube, and while maintaining this state, the tentative sealing may be performed, and the through hole of the bead glass may be plugged. Alternatively, the mercury may be filled into the pre-sealing discharge space at substantially the same time as tentatively sealing the end on the side where the bead glass was fixed.

In this way, it is sufficient for the mercury to have been filled into the pre-sealing discharge space when plugging the through hole of the bead glass, and the time of filling may come before or after tentatively sealing the glass tube.

Note that the “depressurization/filling step” referred to in the present invention is a step of depressurizing the interior of the glass tube, and filling mercury (the mercury body in the embodiment) and rare gases for enclosure in the discharge space.

7. Regarding the Tentative Sealing Step

Although the tentative sealing step is performed before the plugging step of plugging the through holes 210, 523 and 525 of the bead glass 200, 522 and 524 in the above embodiments, the tentative sealing step may be omitted, and the lamp may be manufactured by performing the plugging step after the depressurization/filling step. In this case, however, it is of course necessary to fill the mercury into the pre-sealing discharge space before plugging the through holes of the bead glass.

8. Regarding the Plugging Step

Although removed in the plugging step in the above embodiments, the tentatively sealed part need not be removed as long as the through hole of the bead glass (corresponding to the part that links the interior of the glass tube to the exterior in the fixing step of the present invention) is plugged. Needless to say, however, removing the tentatively sealed part results in a shorter overall length of the lamp.

### INDUSTRIAL APPLICABILITY

The present invention can be used as an external-electrode discharge lamp in which the cataphoresis effect does not readily occur.

1. A dielectric barrier discharge type external-electrode discharge lamp comprising:
a glass tube whose ends are sealed to form a discharge space in which a discharge medium is enclosed; and
two electrodes, each of the electrodes being provided on an outer circumference of a respective end of the glass tube, and the two electrodes and portions of the glass tube between the two electrodes and the discharge space equivalently functioning as a first capacitor and a second capacitor during operation, wherein
a capacitance of the first capacitor and a capacitance of the second capacitor have been adjusted to be equal or close in value.

2. The external-electrode discharge lamp of claim 1, wherein
a difference between values of the capacitance of the first capacitor and the capacitance of the second capacitor is less than or equal to 20% of a smaller one of the values.

3. The external-electrode discharge lamp of claim 1, wherein
portions, of inner circumferential surfaces of the ends of the glass tube, that correspond to the two electrodes are substantially congruent with respect to shape.

4. A manufacturing method for an external-electrode discharge lamp including a glass tube sealed at a first site and a second site, the glass tube having a discharge space in which a discharge medium is enclosed at a reduced pressure, the manufacturing method comprising:
a fixing step of fixing an insert to an inner circumferential surface of the first site, the insert including an end face having a shape substantially the same as a portion of the sealed first site facing the discharge space when the second site is sealed, the end face facing the discharge space, and an exterior and an interior of the glass tube being linked;
a depressurization/filling step of depressurizing the interior of the glass tube and filling the discharge medium; and
a plugging step of plugging a portion linking the exterior and the interior of the glass tube in the fixing step.

5. The manufacturing method for the external-electrode discharge lamp of claim 4, further comprising:
a tentative sealing step of tentatively sealing a site of the glass tube outward of the insert that was fixed to the glass tube, wherein
the tentative sealing step is performed between the filling step and the plugging step.

6. The manufacturing method for the external-electrode discharge lamp of claim 4, wherein
the insert includes a through hole passing between end faces thereof,
an entirety of an outer circumferential surface of the insert and an inner circumferential surface of the glass tube are fused in the fixing step, and
the through hole is plugged in the plugging step.

7. The manufacturing method for the external-electrode discharge lamp of claim 4, wherein
the insert is constituted from glass including a component substantially the same as the glass tube.

8. The manufacturing method for the external-electrode discharge lamp of claim 4, wherein
the second site is tip-off sealed, and
the first site is sealed after the second site has been sealed.

9. A backlight unit including the external-electrode discharge lamp of claim 1 as a light source.

10. The backlight unit of claim 9 being a direct-type backlight unit using a plurality of the external-electrode discharge lamps.
